(19) United States
(12) Patent Application Publication
(10) Pub. No.: US 2025/0103088 A1
(43) Pub. Date: Mar. 27, 2025

(54) VOLTAGE AND CLOCK FREQUENCY MANAGEMENT

(71) Applicant: Micron Technology, Inc., Boise, ID (US)

(72) Inventors: Leon Zlotnik, Camino, CA (US); Leonid Minz, Beer Sheva (IL)

(21) Appl. No.: 18/789,228

(22) Filed: Jul. 30, 2024

Related U.S. Application Data
(60) Provisional application No. 63/584,720, filed on Sep. 22, 2023.

(51) Int. Cl. G06F 1/06

(52) U.S. Cl. CPC G06F 1/06

(57) ABSTRACT

Voltage sensing circuitry and management circuitry provide voltage and clock frequency management. The voltage sensing circuitry may be configured to detect a voltage associated with a system-on-chip (SoC) and determine when the voltage transitions from a first voltage to a second voltage. The management circuitry may be configured to generate clocking signals for the SoC and alter a frequency of the generated clocking signals in response to the detected voltage transition.

### PRIORITY INFORMATION

This Application claims the benefit of U.S. Provisional Application No. 63/584,720, filed on Sep. 22, 2023, the contents of which are incorporated herein by reference.

### TECHNICAL FIELD

Embodiments of the disclosure relate generally to digital logic circuits, and more specifically, relate to voltage and clock frequency management.

### BACKGROUND

A memory system can include one or more digital circuits that can include various circuitry. In general, a portion of the circuitry can provide a voltage signal to power the digital circuits and/or to power components of the memory system.

### BRIEF DESCRIPTION OF THE DRAWINGS

The present disclosure will be understood more fully from the detailed description given below and from the accompanying drawings of various embodiments of the disclosure.

FIG. 1 illustrates an example system including voltage sensing circuits for voltage and clock frequency management in accordance with some embodiments of the present disclosure.

FIGS. 2A-2C illustrate example clocking signals for voltage and clock frequency management in accordance with some embodiments of the present disclosure.

FIG. 3 illustrates an example system including voltage sensing circuits for voltage and clock frequency management in accordance with some embodiments of the present disclosure.

FIG. 4 is a flow diagram corresponding to a method for voltage and clock frequency management in accordance with some embodiments of the present disclosure.

### DETAILED DESCRIPTION

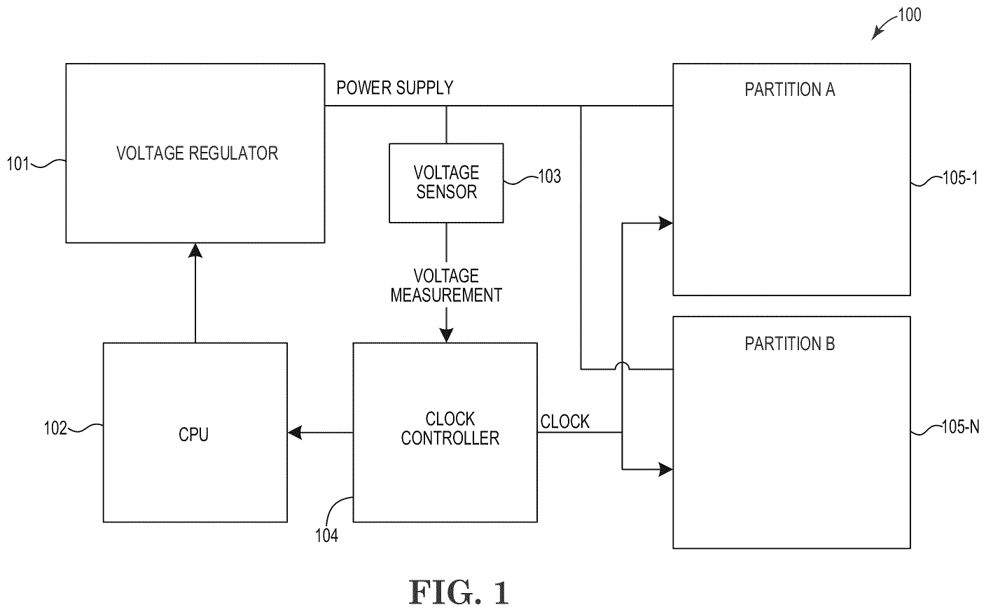

Aspects of the present disclosure are directed to voltage and clock frequency management. Voltage and clock frequency management can be achieved through the use of a voltage sensing circuit that can determine an instantaneous voltage associated with a system (e.g., a System-on-Chip (SoC), application-specific integrated circuit (ASIC), field-programmable gate array (FPGA), or other hardware circuitry) and management circuitry (e.g., clock management circuitry, etc.) to reduce power consumption and/or to improve performance of the system in comparison to approaches that do not employ such management. The voltage sensing circuit(s), in concert with the clock management circuitry described herein can provide benefits in systems that rely on instantaneous (or near-instantaneous) voltage sensing to track, limit, adjust, and/or manipulate power consumption and/or noise dynamically. Examples of apparatuses and systems that employ voltage and clock frequency management in accordance with embodiments of the present disclosure are described below in conjunction with FIG. 1, et alibi.

The voltage and clock frequency management systems and devices described herein can dynamically and automatically adjust generated clocking signals during power mode transitions based on a detected voltage. A voltage sensing circuit can be utilized to detect instantaneous or near instantaneous voltage readings associated with a system and provide the detected voltage to clock management circuitry. The clock management circuitry can generate clocking signals for the system in response to the detected voltage. In this way, the present disclosure provides shorter power mode transition latency compared to previous systems. In addition, the present disclosure allows for power mode transition terminations without performance interruptions. Furthermore, the present disclosure is able to dynamically and automatically adjust to IR drops and/or other types of voltage irregularities while compensating for temperature and current fluctuations. These and other aspects of the present disclosure can also provide for a reduction in power consumption in various types of systems, computing devices, and/or circuits; thereby providing an improvement to computing devices in which aspects of the present disclosure are deployed.

Through utilization of the voltage sensing circuit(s) and/or clock management circuitry described herein, voltage and clock frequency management can be provided to a system and/or components coupled to the system. For example, voltage sensing circuitry can be deployed in a system (e.g., a SoC, ASIC, FPGA, etc.) to detect voltage characteristics (e.g., a voltage drop or “IR drop”) in locations within the system that may be prone to exhibiting IR drop phenomena. As described in more detail herein, responsive to the voltage characteristics being determined by the voltage sensing circuits, the clock management circuitry can alter the frequency of the generated clocking signals for the system. In this way, the frequency of the clocking signals can be locked to correspond with the actual voltage values determined by the voltage sensing circuits.

FIG. 1 illustrates an example system 100 including voltage sensing circuits (e.g., voltage sensor 103, etc.) in accordance with some embodiments of the present disclosure. The example system 100, which can be referred to in the alternative as an “apparatus,” includes a voltage regulator 101 that is configured to generate and apply a power supply signal (e.g., a supply voltage signal) to the voltage sensor 103 (e.g., voltage sensing circuits, etc.) and/or to other components of the system 100. As used herein, a voltage regulator 101 can be a device or system of devices that can manipulate or alter an output voltage. For example, the voltage regulator 101 can include one or more of: a power supply, one or more converters, one or more inverters, one or more generators, among other electrical components that can alter a voltage or current. In another example, the voltage regulator 101 can include batteries or solar elements with a switch that connects different battery elements to manipulate the voltage.

The system 100 is couplable to one or more computing components. The computing components can be external to the system 100 (i.e., the computing components are physically distinct from a chip, such a SoC that the system 100 is deployed on) but are communicatively couplable to the system 100 such that signaling can be exchanged between the system 100 and the computing components. In some embodiments, the computing components can be internal to the system 100 (i.e., physically on the chip). Non-limiting examples of the computing components can include controllers, memory devices, graphics processing units, processors/co-processors, and/or logic blocks, among others that are connected to a computer in which the system 100 operates.

The voltage sensor 103 can include voltage sensing circuits that can be any type of circuit that is configured to instantaneously (or near-instantaneously) sense a voltage or change in voltage (e.g., an IR drop) in the power supply signal. In addition to, or in the alternative, the voltage sensor can include an analog comparator, an oscillator circuit, a phase detection circuit, digital-to-analog converter, and/or an analog-to-digital converter. In some embodiments, the system 100 is a system-on-chip (SoC), application-specific integrated circuit (ASIC), or a field-programmable gate array (FPGA), among other possibilities.

As shown in FIG. 1, the voltage sensor 103 can issue signaling indicative of a voltage error to a clock controller 104 (e.g., clock management circuitry, etc.). The system 100 can include a clock controller 104 that includes clock management circuitry. The clock controller 104 or clock management circuitry can be configured to generate and apply clocking signals to various components of the system 100, such as partition A 105-1, partition B 105-N, and/or additional partitions not illustrated. In some embodiments, partition A 105-1 can be a first logic block and partition B 105-2 can be a second logic block that is separate from the first logic block. Embodiments are not so limited, however, and the clock controller 104 or clock management circuitry can generate and apply clocking signals to components external to the system 100, as described in more detail herein. Advantageously, the clock controller 104 can be configured to alter a frequency of the clock signals generated thereby, as will be described in more detail below.

The partition A 105-1 and/or partition B 105-N can include various hardware that form one or more cores (e.g., “intellectual property (IP) cores”). As used herein, a “core” or “IP core” generally refers to one or more blocks of data and/or logic that form constituent components of an application-specific integrated circuit or field-programmable gate array. The partition A 105-1 and/or the partition B 105-N can be designed, built, and/or otherwise configured to perform specific tasks and/or functions within the systems described herein. In some embodiments, the voltage sensor 103 can take an action (or cause an action to be taken) to track, limit, adjust or manipulate the dynamic power available to the partition A 105-1 and/or the partition B 105-N.

The clock controller 104 can include hardware circuitry configured to perform the operations described herein. For example, the clock controller 104 can include one or more chips or other hardware circuitry that is configured to generate periodically oscillating signals (e.g., square waves) that are applied to components of the system 100. In some embodiments, the clock controller 104 includes throttling circuitry, clock division circuitry, and/or a voltage-controlled oscillator to facilitate embodiments of the present disclosure.

In some embodiments, at least one of the clock controller 104 and/or voltage sensor 103 can be resident on one of the partitions (partition A 105-1, partition B 105-N, etc.). As used herein, the term “resident on” refers to something that is physically located on a particular component. For example, the voltage sensor 103 and/or the clock controller 104 being “resident on” the partition A 105-1 refers to a condition in which the hardware circuitry that comprises the voltage sensor 103 and/or the clock controller 104 is physically located on the partition A 105-1. The term “resident on” may be used interchangeably with other terms such as “deployed on” or “located on,” herein.

In a non-limiting example, the system 100 can include a voltage sensor 103 configured to detect a voltage associated with a system-on-chip (SoC) and determine when the voltage transitions from a first voltage to a second voltage. The voltage can be generated by the voltage regulator 101. In some embodiments, the voltage transition can correspond to a particular voltage change (e.g., a voltage drop or IR drop) which the SoC is consuming. In some embodiments, the voltage change can correspond to a change from a nominal voltage to a retention voltage or a change from a retention voltage to a nominal voltage. As used herein, a nominal voltage refers to a designated or specified voltage level at which an electrical component, device, or system is designed to operate. It can serve as a standard reference point that manufacturers and engineers use to design, build, and operate various electrical and electronic equipment. In this way, the system 100 can operate in a normal mode or operating mode when the nominal voltage is detected by the voltage sensor 103. As used herein, a retention voltage can refer to a minimum voltage for retention of data associated with the system 100. In this way, the retention voltage can refer to a voltage provided by the voltage regulator 101 during a sleep mode or low power mode of the system 100. In these embodiments, the nominal voltage can be a greater voltage compared to the retention voltage.

As described herein, the system 100 further includes clock controller 104 configured to generate clocking signals for the SoC. The clock controller 104 can be further configured to alter a frequency of the generated clocking signals in response to the detected voltage transition. In some embodiments, the frequency of the generated clocking signals is altered to correspond with the value of the detected voltage. In this way, the clock controller 104 can receive a particular voltage value from the voltage sensor 103 and generate a frequency of clocking signals corresponding to the particular voltage value. In some embodiments, the clock controller 104 can lock the frequency of the clocking signals to the detected voltage such that an increase in the detected voltage results in an increase in the frequency of the clocking signals and a decrease in the detected voltage results in a decrease in the frequency of the clocking signals.

In some embodiments, the clock controller 104 can be configured to alter the frequency of the clocking signals by increasing the frequency of the clocking signals when the first voltage is less than the second voltage. The frequency of clocking signals can be referred to as the clock frequency or clock speed. The frequency of the clocking signals is a parameter in digital systems and electronics. The frequency of clocking signals can represent the rate at which a clock signal alternates between its high and low states (or transitions between 1 and 0) within a specific time interval. Clocking signals can be utilized to synchronize various components and operations within a digital and/or analog circuit, ensuring that actions occur at precise and coordinated times. Clock frequency can be measured in hertz (Hz) and represents the number of clock cycles that occur per second. A higher clock frequency generally indicates faster processing capabilities and more rapid data transfer within a system.

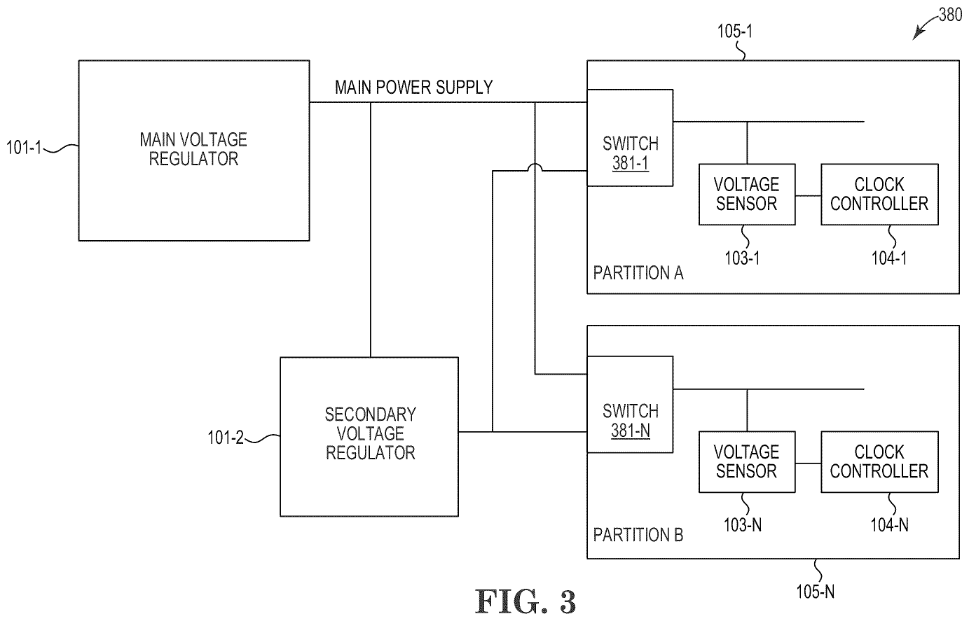

In some embodiments, the clock controller 104 can be configured to alter the frequency of the generated clocking signals in the absence of a guard band. As described herein, the frequency of the clocking signals can be locked to the detected voltage and as the detected reaches a retention voltage, the frequency can be decreased gradually. By altering the frequency of the clocking signals in response to the detected voltage, a guard band (e.g., overshoot/undershoot guard band, etc.) is not necessary to avoid overshoots and undershoots. This process of not utilizing a guard band is illustrated further in FIG. 3. In some embodiments, the clock controller 104 can be configured to alter the frequency of the generated clocking signals in the absence of clock management timing. As described herein, by locking the frequency of the clocking signals to the detected voltage, utilizing the clock management timing is not necessary for transitioning between different power modes. In some embodiments, the clock management timing would force the clocking signals to stop during a retention mode of the system 100 and restart when the retention mode transitioned to the nominal mode. However, since the frequency of the clocking signals are locked with the detected voltage, additional clock management timing circuitry can be removed from the system 100.

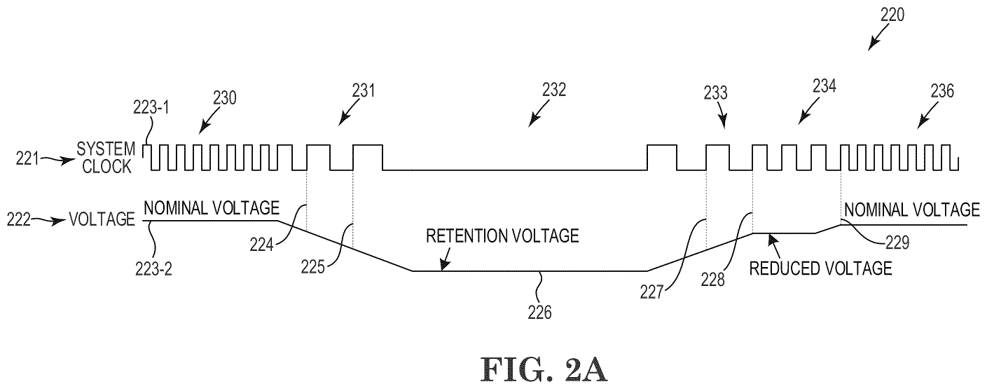

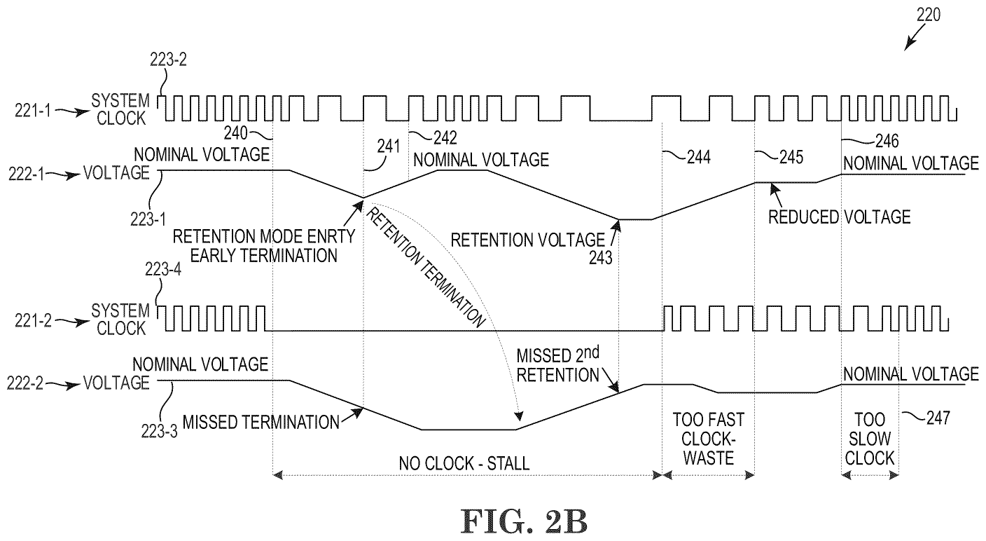

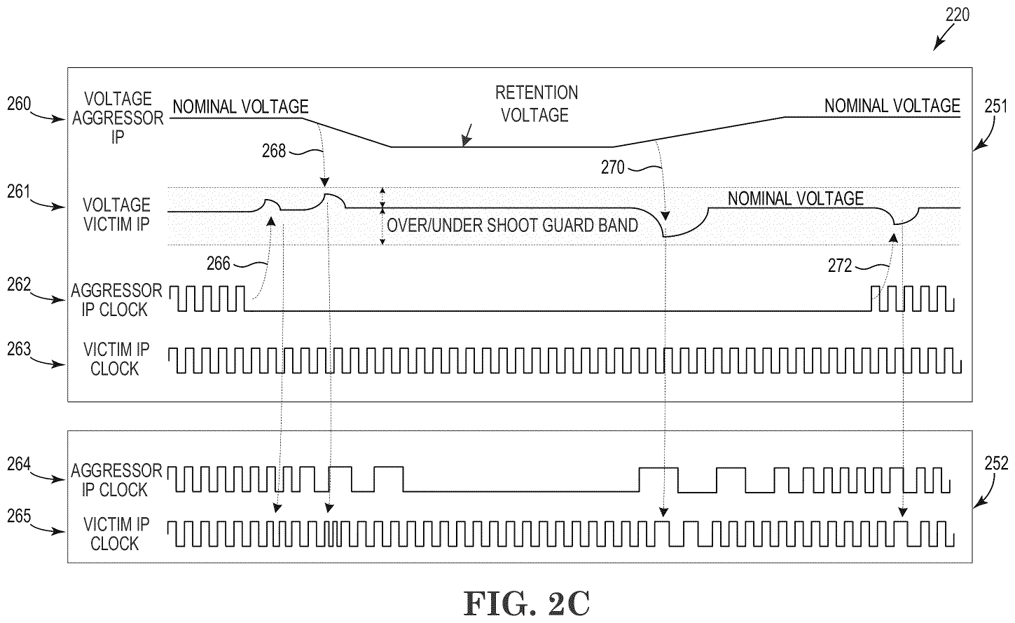

In some embodiments, the clock controller 104 can be configured to apply a power mode transition termination during a power mode transition. As described in reference to FIG. 2B, a power mode transition termination can include a termination signal that stops a transition from a first power mode to a second power mode during the transition period. For example, a retention mode early termination can prevent the system 100 from transitioning from a nominal mode to a retention mode such that the system 100 returns to the nominal mode prior to reaching the retention mode. Since the detected voltage does not reach the retention voltage associated with the retention mode, the clocking signals are not completely stopped. In this way, the frequency of the clocking signals can decrease between the nominal voltage and a termination signal. When the termination signal is received, the detected voltage and the frequency of the clocking signals can increase back to the voltage and frequency of clocking signals associated with the nominal mode.

In some embodiments, the clock controller 104 can include clock management circuitry that comprises throttling circuitry, clock division circuitry, a voltage-controlled oscillator (VCO), or any combination thereof. The throttling circuitry can refer to circuitry utilized to adjust the frequency of the clocking signals and/or the clock speed. The clock division circuitry can refer to an electronic circuit that generates an output clock signal with a frequency that is a fraction of the frequency of its input clock signal. This can be achieved by dividing the number of clock cycles of the input signal to produce a reduced-frequency output signal. The voltage-controlled oscillator can refer to an oscillator circuit that generates an output signal whose frequency can be controlled by an input voltage.

In some embodiments, the voltage sensing circuits of the voltage sensor 103 can be deployed on, or otherwise included in a memory system (e.g., a storage device, a memory module, or a hybrid of a storage device and memory module). Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

In other embodiments, the voltage sensing circuits of the voltage sensor 103 can be deployed on, or otherwise included in a computing device such as a desktop computer, laptop computer, server, network server, mobile computing device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. As used herein, the term “mobile computing device” generally refers to a handheld computing device that has a slate or phablet form factor. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

Such computing devices can include a host system that is coupled to a memory system (e.g., one or more storage devices, memory modules, or a hybrid of a storage device and memory module). A host system can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system uses the storage device, the memory module, or a hybrid of the storage device and the memory module, for example, to write data to the storage device, the memory module, or the hybrid of a storage device and memory module and read data from the storage device, the memory module, or the hybrid of a storage device and memory module.

In these examples, the host system can include a processing unit such as a central processing unit (CPU) that is configured to execute an operating system. In some embodiments, the processing unit can execute a complex instruction set computer architecture, such an x86 or other architecture suitable for use as a CPU for a host system.

A host system can be coupled to a memory system via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system and the memory system. The host system can further utilize an NVM Express (NVMe) interface to access components when the memory system is coupled with the host system by the PCIe interface. The physical host interface can provide an interface for passing control, address, data, and other signals between the memory system and the host system. In general, the host system can access multiple memory sub-systems via a same communication connection, multiple separate communication connections, and/or a combination of communication connections.

A memory system can include any combination of the different types of non-volatile memory devices and/or volatile memory devices. The volatile memory devices can be, but are not limited to, random access memory (RAM), such as dynamic random-access memory (DRAM) and synchronous dynamic random access memory (SDRAM).

Some examples of non-volatile memory devices include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory components such as three-dimensional cross-point arrays of non-volatile memory cells and NAND type memory (e.g., 2D NAND, 3D NAND) are described, the memory device can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory system can also include additional circuitry or components. In some embodiments, a memory system can include a cache or buffer (e.g., DRAM) and address circuitry (e.g., a row decoder and a column decoder) that can receive an address from the memory system controller and decode the address to access the memory device(s).

In some embodiments, memory devices can include local media controllers that operate in conjunction with a memory system controller to execute operations on one or more memory cells of the memory devices. For example, an external controller can externally manage the memory device (e.g., perform media management operations on the memory device). In some embodiments, a memory device is a managed memory device, which is a raw memory device combined with a local controller for media management within the same memory device package. An example of a managed memory device is a managed NAND (MNAND) device.

FIG. 2A-2C illustrate example clocking signals for voltage and clock frequency management in accordance with some embodiments of the present disclosure. Although shown in FIGS. 2A-2C as square waves, the clocking signals 221, 262, 263, 264, and/or 265 can be any periodically occurring signal (e.g., saw waves, sine waves, etc.). The clocking signals 221, 262, 263, 264, and/or 265 can be generated by clock management circuitry, such as the clock management circuitry of the clock controller 104 illustrated in FIG. 1, herein.

FIG. 2A illustrates clocking signals 221 that can be generated by the clock management circuitry in response to a detected voltage 222. In this way, the frequency of the clocking signals 221 can correspond to the level or value of the detected voltage 222. For example, the frequency of the clocking signals 221 can increase when the detected voltage 222 increases and the frequency of the clocking signals 221 can decrease when the detected voltage 222 decreases.

The clocking signals 221 and the detected voltage 222 can include a clocking starting position 223-1 and a voltage starting position 223-2. Although these are visual starting positions, the clocking signals 221 and/or detected voltage 222 have been active prior to the starting position 223-1, 223-2. The detected voltage at the voltage starting position 223-2 can be at a nominal voltage level. As described herein, the nominal voltage level can refer to a voltage that is utilized during a normal operation level for a system. As described herein, the clocking signals 221 can be locked with the voltage level of the detected voltage 222. In this way, the frequency of the clocking signals 221 at position 230 can be a frequency of the clocking signals 221 during a nominal voltage of the detected voltage 222.

In some embodiments, the detected voltage 222 can decrease at positions 224, 225. In some embodiments, the detected voltage 222 can decrease at positions 224, 225 during a transition from a nominal voltage to a retention voltage. In these embodiments, the clock controller 104 as referenced in FIG. 1 or similar clocking circuitry can receive the detected voltage at positions 224, 225 and decrease the frequency of the clocking signals 221 as illustrated at position 231. In previous systems and devices, the clock controller 104 can entirely stop generating the clocking signals 221 when there is an indication that the voltage is transitioning from the nominal voltage to the detected voltage or that the system is transitioning from a wake state to a sleep state. As illustrated in FIG. 2A, the frequency of the clocking signals 221 is decreased during the transition at positions 224, 225 instead of entirely stopping the clocking signals 221. In some embodiments, altering the frequency of the clocking signals 221 during voltage transitions can allow the clock to continue during the voltage transitions compared to previous embodiments where the clock was stopped during the voltage transitions. As described further in reference to FIG. 2B, continuing the clocking signals 221 can allow an early termination signal to be executed without missing the termination and/or stalling the clock.

In some embodiments, the clocking signals 221 can stop during position 232 when the detected voltage 222 reaches the retention voltage at position 226. In some embodiments, the detected voltage 222 can transition from the retention voltage at position 226 to a reduced voltage at position 228. The voltage transition can be illustrated at position 227 with a corresponding frequency of the clocking signals 221 at position 233. The detected voltage 222 can transition from the reduced voltage at position 228 to the nominal voltage at position 229. The frequency of the clocking signals 221 can increase at position 233 with the increased transition of the detected voltage 222 between position 227 and position 228. In a similar way, the frequency of the clocking signals can increase at position 234 with the increased transition of the detected voltage 222 between position 228 and position 229.

As illustrated in FIG. 2A, the clocking signals 221 continue to run during the transition from the nominal voltage to the retention voltage, from the nominal voltage to a reduced voltage, from the retention voltage to the nominal voltage, and/or from the retention voltage to a reduced voltage. In some embodiments, the voltage increase and decrease is performed gradually to avoid transient current events. As used herein, a transient current refers to a temporary or short-lived flow of electric current in a circuit. It can occur when there is a sudden change in voltage or when a circuit element, such as a switch, is suddenly opened or closed. Transient currents can manifest as rapid fluctuations in the flow of electric charge and can lead to changes in voltage levels and other electrical parameters. These types of transient current events can damage electrical components of the circuit and/or disrupt the operation of the electrical components. In these embodiments, the voltage can be transitioned to avoid the transient current events as well as continuing to operate the clocking signals 221.

FIG. 2B illustrates example clocking signals for voltage and clock frequency management in accordance with some embodiments of the present disclosure. FIG. 2B illustrates the difference between the clocking signals 221-1 and detected voltage 222-1 of the present disclosure compared to clocking signals 221-2 and detected voltage 222-2 of previous systems and devices. In addition, FIG. 2B illustrates when there is an early termination of a power mode transition (e.g., power up, power down, retention mode transition, nominal mode transition, etc.).

As used herein, an early termination of a power mode transition refers to stopping the power mode transition and/or altering from a first power mode transition to a second power mode transition. For example, a device or system can receive a command to transition from a nominal mode to a retention mode. In this example, during the transition the device can receive a termination command. This termination command can be an instruction to transition back to the nominal mode prior to reaching the retention mode. In this way, an early termination allows for the device to alter back to an original mode during the transition to a different mode. In another example, the device or system can receive a command to transition from a retention mode to a nominal mode. In this example, during the transition the device can receive a termination command. This termination command can be an instruction to transition to a reduced voltage mode. In this way, the early termination allows the device to transition to a different mode during an initial transition without having to complete the initial transition.

In some embodiments, the starting positions 223-1, 223-2, 223-3, 223-4 can be at a nominal voltage of the device with a corresponding clock frequency. In some embodiments, the nominal voltage can correspond to a nominal mode (e.g., normal operation mode, etc.) for the device. In this way, the clocking signals 221-1 of the present disclosure and the clocking signals 221-2 of the previous system can be illustrated on the same time line. That is, the clocking signals 221-1 and the clocking signals 221-2 can be the same or similar between the starting positions 223-2, 223-4 and the position 240. In addition, the detected voltage 222-1 of the present disclosure and the detected voltage 222-2 of the previous system can be the same nominal voltage between the starting positions 223-1, 223-3 and position 240.

At the position 240, the device can receive an instruction to enter a retention mode or an indication is identified that the device is entering a retention mode. As illustrated in FIG. 2B, the clocking signals 221-1 of the present disclosure alters the generated clocking signals to a lower frequency in response to the voltage level decreasing between the position 240 and the position 241. The clocking signals 221-2 of previous devices stops or deactivates clocking circuitry such that no clocking signals are generated between position 240 and position 241.

At position 241, the device is issued a termination command to terminate the initiation of the retention mode and return to the nominal mode. At position 241, the clocking signals 221-1 of the present disclosure continue to generate clocking signals at a frequency corresponding to the voltage level at position 241. In this way, the clocking signals 221-1 continues through position 241 while the clocking signals 221-2 are still inactive even though there was an early termination of the retention mode.

There is a transition in voltage between position 241 and position 242 to increase the voltage back to the nominal voltage. In these embodiments, the clocking signals 221-1 can increase in frequency as the voltage increases back to the nominal voltage. When the detected voltage 222-1 reaches the nominal voltage, the clocking signals 221-1 can return to the frequency associated with the nominal voltage. As illustrated in FIG. 2B, the clocking signals 221-2 missed the retention termination at 241 and has stalled with no clocking signals. In some previous systems, a counter is utilized to determine timeouts during a transition period or during a transition from a first mode to a second mode.

It can be difficult to determine a quantity of time to transition from the first mode to the second mode. For example, the quantity of time for the transition period can be a function of current, capacitance, or other features of the system. Thus, the counters are set with a large margin of error that can cover a quantity of time for a worst case for such a voltage transition. In addition, it can be difficult to determine when the voltage is stable in the event of a termination signal during the transition between the first mode and the second mode. Thus, a counter timeout with the large margin of error can be utilized in the event of a termination during a transition. In some embodiments, the clocking signals 221-2 can be slowed down or stopped before the voltage 222-2 is lowered. In this way, a margin for error can be at a beginning and/or an end of a transition from a first mode to a second mode. Similar margins of error are provided for a transition from a nominal voltage to a retention voltage and a transition from a retention voltage to a nominal voltage.

Between position 242 and position 243 another signal (e.g., second signal, etc.) is received to enter a retention mode. Thus, the detected voltage 222-1 decreases between the position 242 and the position 243 from the nominal voltage to the retention voltage. In these embodiments, the clocking signals 221-1 can decrease at the same or similar rate as the detected voltage 222-1 decreases. At position 243, the detected voltage 222-1 reaches the retention voltage value. In these embodiments, the clocking signals 221-1 can be stopped or delayed when the detected voltage 222-1 reaches the retention voltage.

As illustrated in FIG. 2B, the clocking signals 221-2 of the previous devices missed the second signal indicating that the device is to transition to a retention mode. Since the clocking signals 221-2 missed the second signal indicating that the device is to transition to the retention mode, the frequency of the clocking signals 221-2 at position 244 is at a nominal frequency, which can waste power at the voltage level of the detected voltage 222-2. Utilizing a clocking frequency that is at a nominal frequency when the voltage is higher than a nominal voltage can result in a power waste. In contrast, the clocking signals 221-1 are at a frequency in lock step with the detected voltage 222-1 and thus is not too fast or too slow. In these embodiments, the detected voltage 222-1 can increase from the retention voltage at position 243 to a reduced voltage at position 245 and then increase from the reduced voltage back to the nominal voltage at position 246. In a similar way as described herein, the clocking signals 221-1 can be altered to have a frequency that corresponds to the detected voltage 222-1 through the transitions.

As illustrated by the clocking signals 221-2, the frequency between position 246 and position 247 is slower than the clocking signals 221-1 and/or the frequency associated with the nominal voltage. In this way, the clocking signals 221-1 are at a higher frequency between position 246 and position 247 compared to the clocking signals 221-2. In this way, the clocking signals 221-1 are representative of the current voltage between position 246 and position 247 while the clocking signals 221-2 are operating at a frequency that is lower than what the voltage 222-2 provides (e.g., clocking signals are too slow, etc.).

FIG. 2C illustrates example clocking signals for voltage and clock frequency management in accordance with some embodiments of the present disclosure. FIG. 2C illustrates a first graphical representation 251 of a voltage aggressor IP 260, a voltage victim IP 261, an aggressor IP clock 262 and a victim IP clock 263 of a previous system and a second graphical representation 252 of an aggressor IP clock 264 and a victim IP clock 265 of the present disclosure. Accordingly, the first graphical representation 251 of the previous system can be readily compared to the second graphical representation 252 of the present disclosure.

Referring to the first graphical representation 251, the voltage aggressor IP 260 can illustrate when the voltage of the system starts at a nominal voltage, moves to a retention voltage, and then moves back to the nominal voltage. The voltage victim IP 261 can illustrate overshoot at position 266 and undershoot at position 272. At position 266, the voltage spike or jump can be due to the aggressor IP clock 262 abruptly stopping. When the clock is abruptly gated or slowed down significantly a dynamic current drops and a resultant voltage jump at position 266 while the voltage regulator catches up and then returns to normal. At position 272, the voltage drop can be due to the aggressor IP clock 262 restarting and/or the dynamic current suddenly increasing. In previous systems, an over/undershoot guard band can be utilized to protect the system from the overshoot at position 266 and the undershoot at position 272.

In addition, the voltage victim IP 261 illustrates an artifact over/undershoot at position 268 and position 270. In some embodiments, the voltage regulator (e.g., voltage regulator 101 as referenced in FIG. 1, etc.) can include an artifact in response to being instructed to change a voltage output. In some embodiments, the artifact at position 268 and/or position 270 can be a jump (quick increase) or a drop (quick decrease) based on a reaction of the particular voltage regulator to the instruction. In some embodiments, the voltage aggressor IP can share a voltage regulator with other voltage aggressor Ips and thus the voltage victim IP 261 may result in artifacts based on their performance. In other embodiments, the artifacts at position 268 and/or position 270 can be a result of switching between a first voltage regulator and a second voltage regulator (e.g., main voltage regulator 101-1 and secondary voltage regulator 101-2 as referenced in FIG. 3, etc.). In response to this switch, the current on the first voltage regulator suddenly drops and hence the second voltage regulator jumps up until it reacts. Similarly, when the voltage returns to the retention voltage, the current goes from the second voltage regulator to the first voltage regulator and the voltage drops. In some embodiments, the artifacts can be caused by one or more of a leakage current and/or a capacitance.

Referring to the second graphical representation 252, the aggressor IP clock 264 of the present disclosure illustrates how the frequency of the clocking signals decreases as the system transitions from the nominal voltage to the retention voltage. The victim IP clock 265 of the present disclosure illustrates that the overshoot at position 266 would result in a high frequency and the undershoot at position 272 would result in a decreased frequency. In some previous embodiments, a guard band was utilized to protect the system from over/undershoots. In some embodiments, the guard band is a system tolerance to the voltage disruption. For example, the guard band can be a system tolerance range with a high voltage and a low voltage extremes on either side of a target voltage. The present disclosure provides a tighter (better) tolerance range with the high voltage and the low voltage extremes by monitoring the voltage changes and adjusting the clock frequency in response to the voltage changes.

In some embodiments, the frequency of the clocking signals can be adjusted during a spike in voltage and/or a drop in voltage. For example, the frequency of the clocking signals can be adjusted in real time during an artifact associated with a voltage regulator. As described herein, an artifact of the voltage regulator can be an unintended result of the non-ideal voltage regulator during operation. For example, an artifact can be an output voltage spike during a transition such as a rapid change in a load or current. In other embodiments, the frequency of the clocking signals can be adjusted in real time when a different aggressor IP shares the same voltage supply or voltage regulator. In these embodiments, the different aggressor IP can cause fluctuations in the detected voltage (e.g., voltage drops, voltage spikes, etc.). In these embodiments, the present disclosure can adjust the frequency of the clocking signals to mitigate the alterations in voltage. However, previous systems may be negatively affected by the voltage variations during a nominal voltage of the previous system.

In the previous embodiments, the victim IP clock 263 does not slow down during the voltage undershoot at position 270 or position 272. In this way, the voltage decreases while the victim IP clock 263 remains constant. To ensure the previous system is functional, it can be needed to ensure that the victim IP clock 263 is fully functional at the lower voltage occurring at position 270 and/or position 272. Maintaining this full functionality of the victim IP clock 263 can require additional resources, including, but not limited to: relatively faster cells, relatively higher power, a larger area, longer time closures, among other resources.

In the previous embodiments, a prerequisite for stopping the clock can include stopping the clock before starting to lower the voltage. Stopping the clock can require finishing or completing a particular operation. In addition, a pre-requisite for starting the clock can be raising the voltage until a timeout before starting the clock or beginning the operation of starting the clock. In the present disclosure these pre-requisites can be removed since the clock does not have to be stopped before lowering the voltage and the voltage does not have to reach a target voltage before starting the clock or speeding up the clock.

FIG. 3 illustrates an example system 380 including voltage sensing circuits for voltage and clock frequency management in accordance with some embodiments of the present disclosure. The example system 380, which can be referred to in the alternative as an “apparatus,” includes a main voltage regulator 101-1 and a secondary voltage regulator 101-2 that are configured to generate and apply a power supply to the system 380. In some embodiments, the system 380 can include the same or similar elements as system 100 as referenced in FIG. 1. Some or all of the functions described herein can also be performed by the system 100 as referenced in FIG. 1.

The system 380 can include a plurality of partitions (e.g., partition A 105-1, partition B 105-N, etc.). In some embodiments, the main voltage regulator 101-1 and/or the secondary voltage regulator 101-2 can be connected to a first switch 381-1 and/or a second switch 381-N. In these embodiments, the first switch 381-1 and/or a second switch 381-N can allow the main voltage regulator 101-1 and/or the secondary voltage regulator 101-2 to provide electrical power to the corresponding components of the plurality of partitions. In some embodiments, the main voltage regulator 101-1 and/or the secondary voltage regulator 101-2 can provide power to the partition A 105-1 that can be utilized by a first voltage sensor 103-1 and/or a first clock controller 104-1 as described herein. In a similar way, the main voltage regulator 101-1 and/or the secondary voltage regulator 101-2 can provide power to the partition B 105-N that can be utilized by a second voltage sensor 103-N and/or a second clock controller 104-N as described herein. In this way, the first clock controller 104-1 can utilize a detected voltage from the first voltage sensor 103-1 to generate clocking signals for components associated with the partition A 105-1. Similarly, the second clock controller 104-N can utilize a detected voltage from the second voltage sensor 103-N to generate clocking signals for components associated with the partition B 105-N.

In some embodiments, one or more of the voltage sensors 103-1, 103-N can determine characteristics of a voltage received from one or more of the voltage regulators 101-1, 101-2. As described herein, the characteristics of the voltage can be a detected voltage determined by the one or more voltage sensors 103-1, 103-N. The detected voltage can be a voltage received at a corresponding switch (e.g., first switch 381-1, second switch 381-2, etc.) coupled to the main voltage regulator 101-1 and/or the second voltage regulator 101-2.

In some embodiments, one or more of the voltage sensors 103-1, 103-N can determine when the characteristics of the voltage transition through increasing voltage or transition through decreasing voltage. As described herein, the voltage transition can be a transition from a first power mode to a second power mode. In some embodiments, a termination of the transition between the first power mode and the second power mode can occur. In these embodiments, the detected voltage transition can be detected in a similar way as the initiation of the transition.

In some embodiments, one or more of the clock controllers 104-1, 104-N can generate clocking signals for the system 380 (e.g., SoC, external components, etc.). As described herein, the clock controllers 104-1, 104-2 can include clocking circuitry to generate clocking signals at a particular frequency.

In some embodiments, one or more of the clock controllers 104-1, 104-N can alter a frequency of the generated clocking signals in response to the characteristics of the increasing voltage or decreasing voltage. As described herein, the generated clocking signals can be locked to the detected voltage. In this way, the frequency of the clocking signals can increase as the voltage increases and the frequency of the clocking signals can decrease as the voltage decreases.

In some embodiments, one or more of the clock controllers 104-1, 104-N can apply the clocking signals having the altered frequency to one or more of the plurality of computing components or to one or more components of the SoC. As described herein, the plurality of computing components can be external to the SoC. In other embodiments, the one or more components of the SoC are resident on the SoC and comprise one or more logic blocks. In some embodiments, the one or more of the plurality of computing components comprise a memory device, a controller, a graphics processing unit, a processing device, or a logic block, or any combination thereof. In some embodiments, the SoC comprises an application-specific integrated circuit.

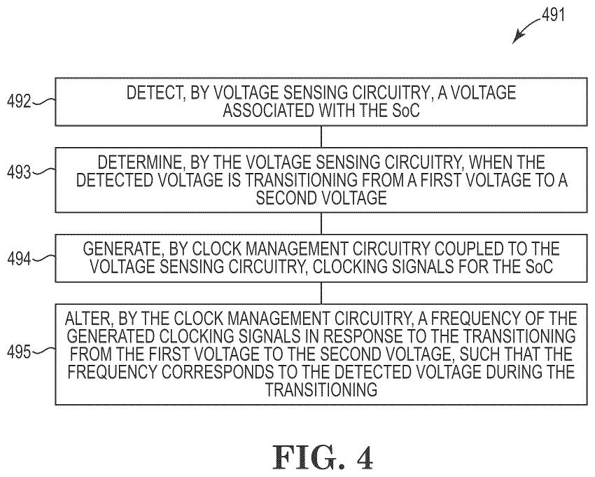

FIG. 4 is a flow diagram corresponding to a method 491 for voltage and clock frequency management in accordance with some embodiments of the present disclosure. The method 491 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 491 is performed by one or more components of the system 100 of FIG. 1 and/or one or more components of the system 380 illustrated in FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 492, the method 491 can include detecting, by voltage sensing circuitry, a voltage associated with the SoC. In some embodiments, the voltage sensing circuit can be resident on the SoC and/or remote from the SoC. As described herein, the voltage associated with the SoC can be a voltage detected at a voltage regulator of the SoC. In this way, the voltage provided to the plurality of components associated with the SoC can be detected by the voltage sensing circuitry and the detected voltage can be provided to the clocking management circuitry.

At operation 493, the method 491 can include determining, by the voltage sensing circuitry, when the detected voltage is transitioning from a first voltage to a second voltage. As described herein, the voltage transitioning from the first voltage to the second voltage can be an indicator that the SoC is transitioning from a first power mode to a second power mode. In this way, the voltage sensing circuitry can be utilized to determine when the SoC is transitioning from a first power mode to a second power mode.

At operation 494, the method 491 can include generating, by clock management circuitry coupled to the voltage sensing circuitry, clocking signals for the SoC. The clock management circuitry can include components to generate clocking signals at a particular frequency. In addition, the clock management circuitry can include components to alter the frequency of the clocking signals and/or receive a detected voltage from the voltage sensing circuitry.

At operation 495, the method 491 can include altering, by the clock management circuitry, a frequency of the generated clocking signals in response to the transitioning from the first voltage to the second voltage, such that the frequency corresponds to the detected voltage during the transitioning. In these embodiments, the frequency of the clocking signals is locked to alter with the detected voltage. In this way, the frequency of the clocking signals can increase when the detected voltage increases and decrease when the detected voltage decreases.

In some embodiments, the method 491 can include determining initiation of a retention mode of the SoC, detecting, by the voltage sensing circuitry, the voltage associated with the SoC is transitioning to a lower voltage in response to the initiation of the retention mode, and altering, by the clock management circuitry, the frequency to a corresponding lower frequency based on the transitioning to the lower voltage. In these embodiments, the SoC is transitioning to a retention mode and corresponding retention voltage. In these embodiments, the voltage sensing circuitry can detect the decrease in voltage from a nominal voltage to the retention voltage. As the voltage decreases from the nominal voltage to the retention voltage, the clock management circuitry can decrease the frequency of the clocking signals at a corresponding rate until the voltage reaches the retention voltage and the clock management circuitry can stop generating clocking signals.

The method 491 can include generating, by the clock management circuitry, the clock signals at the frequency directly with the detected voltage value. As described herein, the frequency of the clocking signals can correspond directly with the detected voltage such that increases in detected voltage result in increases in the frequency of generated clocking signals. In some embodiments, the method 491 can include generating, by the clock management circuitry, the clock signals in the absence of a predicted voltage associated with the SoC. Since the actual detected voltage is utilized, a predicted voltage value is not needed to generate the frequency of the clocking signals. Utilizing the actual detected voltage and not a predicted voltage, the systems and devices described herein can dynamically change even when there is a termination during a transition between power modes.

The method 491 can include generating, by the clock management circuitry, the clock signals in the absence of: a speed up pre-requisite when the first voltage is less than the second voltage, and/or a slow down pre-requisite when the first voltage is greater than the second voltage. In some previous embodiments, the speed up pre-requisite for a previous system can include raising the voltage prior to starting the clock and/or increasing the frequency of the clock. Thus, the present disclosure does not need to increase the voltage prior to starting the clock. The slow down pre-requisite can include stopping the clock and/or slowing down the clock prior to starting to lower the voltage. However, the present disclosure is able to alter the clocking frequency in response to the detected voltage and thus does not need to utilize the speed up pre-requisite or the slow down pre-requisite.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. An apparatus, comprising:
voltage sensing circuitry configured to:
detect a voltage associated with a system-on-chip (SoC); and
determine when the voltage transitions from a first voltage to a second voltage; and
management circuitry configured to:
generate clocking signals for the SoC; and
alter a frequency of the generated clocking signals in response to the detected voltage transition.

2. The apparatus of claim 1, wherein the management circuitry is configured to alter the frequency of the clocking signals by decreasing the frequency of the clocking signals when the first voltage is greater than the second voltage.

3. The apparatus of claim 1, wherein the management circuitry is further configured to alter the frequency of the clocking signals by increasing the frequency of the clocking signals when the first voltage is less than the second voltage.

4. The apparatus of claim 1, wherein the management circuitry is further configured to alter the frequency of the clocking signals during a voltage under/overshoot.

5. The apparatus of claim 1, wherein the management circuitry is configured to lock the frequency of the clocking signals to the detected voltage.

6. The apparatus of claim 1, wherein the management circuitry is further configured to alter the frequency of the generated clocking signals in an absence of clock management timing to force the clocking signals to stop during a retention mode and restart the clocking signals when the retention mode is transitioned to a nominal mode.

7. The apparatus of claim 1, wherein the management circuitry is further configured to apply a power mode transition termination during a power mode transition.

8. The apparatus of claim 1, wherein the management circuitry comprises throttling circuitry, clock division circuitry, or a voltage-controlled oscillator, or any combination thereof.

9. The apparatus of claim 1, wherein the voltage sensing circuitry comprises an analog comparator, an oscillator circuit, a phase detection circuit, or an analog-to-digital converter, or any combination thereof.

10. A method, comprising:
detecting, by voltage sensing circuitry, a voltage associated with a system-on-chip (SoC);
determining, by the voltage sensing circuitry, when the detected voltage is transitioning from a first voltage to a second voltage;
generating, by management circuitry coupled to the voltage sensing circuitry, clocking signals for the SoC; and
altering, by the management circuitry, a frequency of the generated clocking signals in response to the transitioning from the first voltage to the second voltage, such that the frequency corresponds to the detected voltage during the transitioning.

11. The method of claim 10, further comprising:
determining initiation of a retention mode of the SoC;
detecting, by the voltage sensing circuitry, the voltage associated with the SoC is transitioning to a lower voltage in response to the initiation of the retention mode; and
altering, by the management circuitry, the frequency to a corresponding lower frequency based on the transitioning to the lower voltage.

12. The method of claim 11, further comprising:
determining an early termination of the retention mode of the SoC;
detecting, by the voltage sensing circuitry, the voltage associated with the SoC is transitioning to a higher voltage in response to the termination of the retention mode; and
altering, by the management circuitry, the frequency to a corresponding higher frequency based on the transitioning to the higher voltage.

13. The method of claim 10, further comprising generating, by the management circuitry, the clock signals at the frequency to directly correspond with the detected voltage.

14. The method of claim 13, further comprising generating, by the management circuitry, the clock signals in an absence of a predicted voltage associated with the SoC.

15. The method of claim 10, further comprising generating, by the management circuitry, the clock signals in the absence of a speed up pre-requisite that includes increasing the voltage to a target voltage prior to generating the clocking signals.

16. A system, comprising:
a plurality of computing components coupled to a system-on-chip (SoC), wherein the SoC comprises:
a voltage regulator;
a voltage sensing circuit configured to:
determine a voltage received from the voltage regulator; and
determine when a voltage transition corresponds to an increasing voltage or a decreasing voltage; and
management circuitry configured to:
generate clocking signals for the SoC;
alter a frequency of the generated clocking signals in response to the increasing voltage or decreasing voltage; and
apply the clocking signals having the altered frequency to one or more of the plurality of computing components or to one or more components of the SoC.

17. The system of claim 16, wherein a portion of the plurality of computing components are external to the SoC.

18. The system of claim 16, comprising a secondary voltage regulator coupled to the voltage sensing circuit.

19. The system of claim 18, wherein voltage regulator and the secondary voltage regulator are coupled to the voltage sensing circuity by a switch.

20. The system of claim 16, wherein the one or more components of the SoC are resident on the SoC and comprise one or more logic blocks.
